(19) United States
(12) Patent Application Publication
(10) Pub. No.: US 2005/0081444 A1
(43) Pub. Date: Apr. 21, 2005

(54) CATALYTIC PARTIAL OXIDATION PROCESSOR WITH HEAT EXCHANGER FOR CONVERTING HYDROCARBON FUELS TO SYNGAS FOR USE IN FUEL CELLS AND METHOD

(75) Inventors: Amarendra Anumakonda, Naperville, IL (US); Robin L. Wang, Palatine, IL (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 10/605,688

(22) Filed: Oct. 17, 2003

(51) Int. Cl. C01B 3/26

(52) U.S. Cl. 48/214 A; 48/95; 48/198.7; 48/215; 48/214 R; 48/127.9

(57) ABSTRACT

A catalytic partial oxidation processor comprising at least one catalytic partial oxidation reactor disposed in a shell having an inlet and outlet such that heat from partial oxidation in the reactor transfers from the reactor to heat exchange fluid in the shell. The heat transfer serves to keep the precatalyst zone of the partial oxidation reactor cool and the post catalyst section of the partial oxidation reactor hot while also providing an efficient heat recovery system. A system for producing electric power comprises such a catalytic partial oxidation processor and a fuel cell disposed for receiving the exit gas stream and consuming the hydrogen to produce electric power. Corresponding methods are also disclosed.

### BACKGROUND OF INVENTION

The present invention relates to catalytic partial oxidation (CPOX) of hydrocarbon fuels and, more particularly, to improved methods and devices for CPOX of liquid hydrocarbon fuels for production of syngas for use in fuel cells and the production of electric power.

Interest continues in methods of using hydrocarbon fuels to produce a gaseous product stream of hydrogen and carbon monoxide (syngas), as well as using the gaseous product stream to fuel a fuel cell system, such as a solid oxide fuel cell system (SOFC). The contemplated uses of fuel cells have been many, but significant attention has recently been given to transport vehicles. In that regard, fuel cells have been considered as replacements for internal combustion engines due to the advantages of greater efficiency and reduced emissions.

One process of converting hydrocarbon fuels to syngas is catalytic partial oxidation. Suitable fuels for partial oxidation include light hydrocarbons (i.e., molecules with up to 5 carbon atoms) and complex or heavy hydrocarbon fuels (molecules with greater than 5 carbon atoms). Partial oxidation is an exothermic process and, therefore, does not have the disadvantage of requiring heat input and related transfer inefficiencies, but the heat produced by the process is substantial and can be a hazard. With increasing size and scale of catalytic partial oxidation reactors such as in electric vehicles, heat produced by the process affects the robustness of the process and can become a significant safety hazard.

Thus, there is a substantial need for an improved processes and equipment for CPOX, particularly for supplying a hydrogen/carbon monoxide fuel to a fuel cell system, such as a solid oxide fuel cell system.

### SUMMARY OF INVENTION

This invention addresses the needs described above by providing a catalytic partial oxidation processor comprising at least one catalytic partial oxidation reactor disposed in a tubular reactor encased in a shell that receives a flow of heat exchange fluid. The shell has an inlet for receiving the flow of heat exchange fluid and an outlet for discharging the flow of heat exchange fluid. Heat from the partial oxidation in the at least one catalytic partial oxidation tubular reactor transfers from the at least one catalytic partial oxidation reactor to the heat exchange fluid in the shell. The heat exchange fluid controls the temperature of the catalytic partial oxidation reactor and the surrounding environment and, in preferred embodiments, can maintain the reactor at or near optimal conditions. In addition, the heat exchange fluid reduces the possibility of heat damage to the reactor in the surrounding area and allows for more safe, efficient and reliable operation of the reactor. Furthermore, the heat transferred to the heat exchange fluid can be used elsewhere such as in preheating the hydrocarbon fuel.

This invention also encompasses a corresponding method for catalytic partial oxidation of hydrocarbon fuel. This method comprises feeding a feed gas mixture comprising an oxygen containing gas and a hydrocarbon fuel through at least one catalytic partial oxidation reactor disposed in a shell, reacting the feed gas mixture in the at least one catalytic partial oxidation reactor in the presence of an oxidation catalyst to convert the feed gas mixture to an exit gas mixture of hydrogen and carbon monoxide, and passing a heat exchange fluid through the shell and past the at least one catalytic partial oxidation reactor such that heat from the partial oxidation in the at least one catalytic partial oxidation reactor transfers from the reactor to the heat exchange fluid in the shell.

Furthermore, this invention encompasses a system for producing electric power comprising the above-described catalytic partial oxidation processor and a fuel cell disposed for receiving the exit gas stream of the processor and consuming hydrogen in the exit gas stream to produce electric power. This invention also encompasses a corresponding method for producing electric power.

### BRIEF DESCRIPTION OF DRAWINGS

FIG. 1 is a schematic diagram of a fuel system for a solid oxide fuel cell system according to an embodiment of the present invention;

FIG. 2 is a schematic diagram of a catalytic partial oxidation reactor according to an embodiment of the present invention and which can be utilized in the system of FIG. 1; and

FIG. 3 is a side elevation view of a catalytic partial oxidation processor according to an embodiment of the present invention in which a plurality of reactors such as in FIG. 1 are disposed in a heat exchanger shell.

### DETAILED DESCRIPTION

As summarized above, this invention encompasses processes and equipment for producing syngas, a mixture of hydrogen and carbon monoxide, via catalytic partial oxidation (CPOX) of heavy hydrocarbons. This invention also encompasses production of electric power with fuel cells using the produced syngas as fuel. Embodiments of this invention are described below. Preferred embodiments of this invention are capable of producing syngas with reduced more reliably and safely due to transfer of exothermic heat produced by the catalytic partial oxidation reaction.

In an embodiment of the invention, the catalytic structure or catalyst employed for the partial oxidation of hydrocarbons is in the form of a noble metal deposited on an open-channel support. The manner of constructing such a catalyst is well known in the art and is shown, for example, by Komiyama in “Design and Preparation of Impregnated Catalysts,” Catal. Rev. 27, 341 (1985). Such catalyst structures are also disclosed in U.S. Pat. No. 6,221,280, the disclosure of which is expressly incorporated herein by reference in its entirety. The preferred noble metals include rhodium, platinum, palladium, and iridium. A more preferred metal is rhodium because of the lower stability of its sulfide compounds at high temperature, high catalytic activity towards CPOX, and lower vapor pressure at operating temperature.

In the foregoing preferred embodiment, the weight percentage or metal loading of the catalyst usefully ranges from about 5 to 30 wt. % based on the support, and preferably from about 10 to 25 wt. %. A more preferred metal loading is about 15 wt. %.

While porous alpha alumina is used in the examples of this invention as the open-channel support, other materials, such as cordierite, zirconia, stabilized gamma alumina, and metals coated with chemically inert ceramic coatings can be used. Similarly, configurations in addition to a honeycomb monolith can be used. For example, the catalyst may be used in a mesh form or may be a coating on a metallic mesh. In general, configurations that provide an open channel type structure or a substantially non-tortuous path while maintaining efficient heat transfer can be used. When multiple catalysts are employed, both catalysts are supported on an open channel support. The multiple catalysts can be arranged in series or can be admixed.

Turning to the drawings in which like reference numerals indicate like parts throughout the views, an electric power system 10 made in accordance with an embodiment of this invention is illustrated. The electric power system 10 generally comprises a source of heavy hydrocarbon fuel 12, a source of oxygen such as air 14, a CPOX processor 16 in which the heavy hydrocarbon fuel and oxygen react to form syngas and heat from the exothermic reaction is removed, and an SOFC system 18 that receives the syngas as fuel for producing electricity.

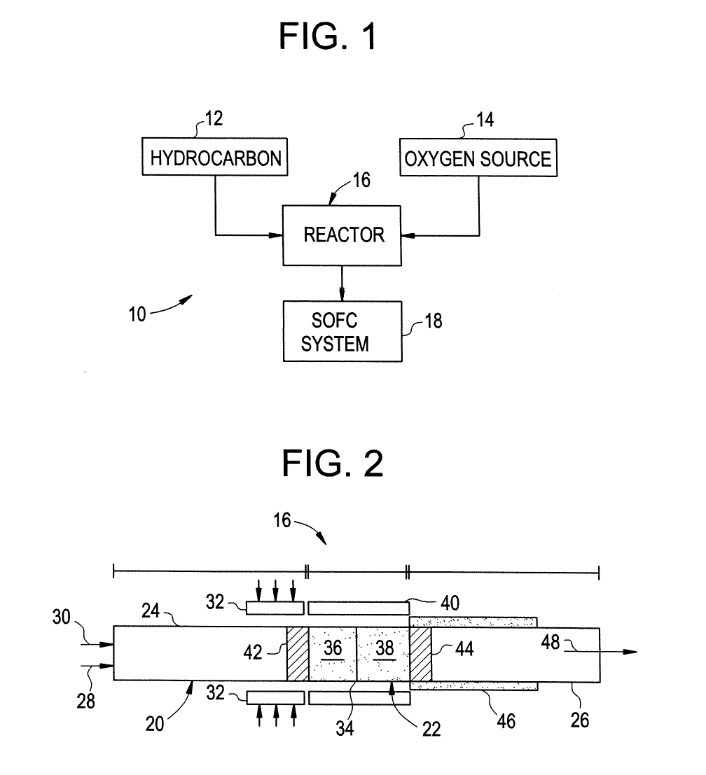

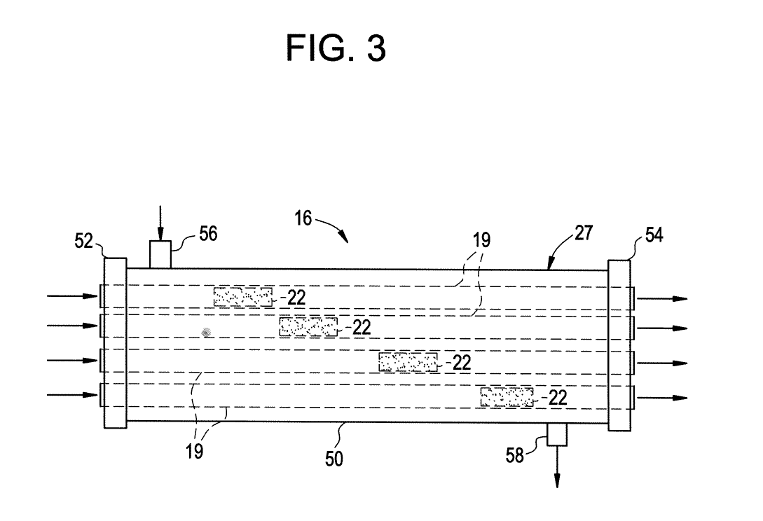

FIG. 2 schematically illustrates a CPOX reactor 19 in accordance with this embodiment of the invention. The CPOX reactor 19 forms part of the CPOX processor 16. Generally, the CPOX reactor 19 comprises a reactor tube 20 that includes a catalytic reaction zone 22, a pre-reaction zone 24 upstream of the catalytic reaction zone, and a post reaction zone 26 downstream of the catalytic reaction zone. As illustrated in FIGS. 1 and 3, the CPOX reactor 19 is preferably disposed in a heat exchanger shell 27 which is described in more detail below.

The reactor 19 into which the feed gas mixture is routed includes a plug flow reactor 20 which is of a tubular shape in this embodiment. The reactor tube 20 may be constructed of quartz or other materials, which can withstand temperatures up to about 1300° C. and are substantially chemically inert to hydrocarbon oxidation or carbon formation. These other materials can include quartz-lined steel, high temperature ceramics, ceramic metal composites, nickel based superalloys, cobalt based superalloys, and, in general, high temperature metals and metals protected by ceramic coatings.

A hydrocarbon fuel inlet 28 and an air/oxidant inlet 30 feed hydrocarbon fuel and oxygen containing air into the pre-reaction zone 24. The hydrocarbon fuel and air mix to form a feed gas mixture. In one embodiment of the invention, the hydrocarbon inlet 28 is desirably a fine mist spray nozzle such as an air atomizing nozzle. Although the fine mist spray nozzle is desirable, other types of liquid hydrocarbon fuel vaporizers can also be used. In another embodiment of the invention, hydrocarbon fuel in fuel inlet 28 may be suitably constructed so that the liquid hydrocarbon fuel would be drawn into the oxidant flow 30 using wicks or other porous media. In this configuration, the hydrocarbon fuel air mixture is delivered to the catalyst not as a fine mist but rather as a homogenous gas phase mixture.

A catalytic structure 34 is disposed in the catalytic reaction zone 22 and extends from the pre-reaction zone 24 to the post reaction zone 26 of the reactor 19. The catalytic structure comprises an oxidation catalyst 36 supported on an open channel support. The catalytic structure 34 can be made in a manner as described herein above.

In one embodiment of the invention, a heating means 40 is disposed about the catalytic reaction zone 22 for initially heating the catalytic structure 34 to initiate the catalytic partial oxidation reaction of the feed gas mixture. The heater 40 can be a heating strip or other heating means. In another embodiment of the invention, heating means 40 can be constructed to be of material with high thermal conductivity so that the heat transfer from surrounding fluid (for instance the shell side fluid) might more effectively occur onto the catalyst 36.

A particular reaction temperature may have deleterious effects on CPOX processing, such as sulfur formation on the catalyst, incomplete oxidation, and by-product formation. To achieve the desired effects of the reaction temperature while seeking to avoid the deleterious effects, the reaction temperature in the catalytic reaction zone 22 is usefully maintained of about 1000° C. It is preferred that the reaction temperature ranges from about 900° C. to 1300° C. Above a temperature of about 1300° C., the system operation requires more oxygen input which reduces CO and H₂ yields. In addition, the high temperatures can cause undesirable rates of degradation of materials of construction. Below a reaction temperature of about 900° C., there tends to be greater reactor instability that may involve carbon deposition or sulfidation of the catalyst 18. A more preferable reaction temperature range for this embodiment of the invention is between about 900° C. to 1100° C.

A pair of radiation shields 42 and 44 are disposed in the reactor shell 20 and are configured in the shape of a cylindrical plugs and made of a high temperature ceramic with an open channel structure. The shields 42 and 44 can be made of the same material that forms the open channel support of the catalytic structure. One shield 42 is a pre-reaction shield and is disposed in the pre-reaction zone 24 adjacent the catalytic structure 34. The pre-reaction radiation shield 42 is disposed in the pre-reaction zone 24. The cooled pre-reaction radiation shield 42 reduces the occurrence of premature catalytic partial oxidation reaction or flashback in the preaction zone 24. This substantially reduces formation of carbon deposits in the preaction zone 24.

The post reaction radiation shield 44 is disposed in the post reaction zone 26 adjacent to and downstream of the catalytic structure 34. Insulation 46 is disposed about the exterior of the reactor shield 20 at the post reaction zone 26 proximate the post reaction radiation shield 44 and for a distance downstream of the post reaction radiation shield when necessary to maintain the exit gas stream and the post reaction zone adjacent the catalytic reaction zone at a temperature greater than about 600° C. until the conversion of the feed gas mixture to hydrogen and carbon monoxide is substantially entirely complete. Suitable insulation includes quartz, wool, and other high temperature insulations. Preferably, the temperature of the post reaction zone is maintained at a temperature greater than about 700° C. If not necessary to maintain the temperature of the exit gas, the insulation can be eliminated.

Turning to FIG. 3, a preferred embodiment of the CPOX processor 16 is shown comprising the heat exchanger shell 27 and a plurality of CPOX reactor tubes 19 disposed in the heat exchanger shell parallel to and spaced from one another.

The heat exchanger shell 27 comprises a cylindrical shell body 50 and a pair of manifolds 52 and 54, one manifold at one end of the shell body and the other manifold at the opposite end of the shell body. The plurality of CPOX reactor tubes 19 extend from the first manifold 52 to the second manifold 54.

The heat exchanger shell 27 also includes a heat exchange fluid inlet 56 and a heat exchange fluid outlet 58. The heat exchange fluid inlet 56 is positioned for receiving a flow of heat exchange fluid and is desirably proximate one of the manifolds 52 in the shell body 50. The heat exchange fluid outlet 58 is positioned to discharge the flow of heat exchange fluid from the heat exchanger shell 27 and is desirably positioned proximate the opposite manifold 54 in the shell body 50 and at the opposite side of the shell body from the heat exchange fluid inlet 56.

Any conventional heat exchange fluid can be used. Suitable heat exchange fluids include air, water, oil, and the like. In the preferred embodiment of the invention, cold fluid enters the heat exchanger inlet 56 and serves to keep the pre catalyst zone of the CPOX tubular reactors 19 cool and the post catalyst regions of tubular CPOX reactors 19 hot with the heat recovered as the heat transfer fluid traverses the length of the hot catalyst section of the CPOX reactor tube 19. In one embodiment of the invention, the position of the catalysts 22 in all the CPOX reactor tubes may be lined up vertically with the inlet heat transfer fluid flow conducted such that each CPOX reactor tube 19 receives a rivulet of the cold inlet heat transfer fluid. In another embodiment of the invention, the inlet heat transfer fluid entering in 56 is not conducted to individual CPOX tubes and here the catalyst 22 positioned in each successive CPOX tube (top to bottom) could be offset by a definite amount as shown in FIG. 3. In a preferred embodiment, the catalytic reaction zones 22 of the respective CPOX reactor tubes are offset from one another and staggered longitudinally from one another in the heat exchanger shell 27. Spacing the catalytic reaction zones 22 within the heat exchanger shell 27 distributes the heat produced by the catalytic oxidation reactions along the heat exchanger shell for more efficient heat transfer. In yet another embodiment of the invention, the catalyst 22 positioned in each successive tube may be offset by varying amounts, increasing in offset as we proceed horizontally from inlet position 56 to outlet position 58. This staggered positioning also prevents production of excessive heat or hot spots in any part of the heat exchanger shell.

In operation according to the above-described embodiment of this invention, the electric power system 10 converts the hydrocarbon fuel source 12 to syngas and uses the syngas as a fuel for a fuel cell system 18, either directly or after treatment for desulfurization or temperature compatibility by routing it to a fuel cell system such as a solid oxide fuel cell system (SOFC).

The hydrocarbon fuels of the fuel source 12 can light or heavy hydrocarbon fuels. A “light hydrocarbon” is a hydrocarbon molecule with up to 5 carbon atoms. A “heavy hydrocarbon” is defined as a hydrocarbon molecule having at least 6 carbon atoms, and a “heavy hydrocarbon fuel” is defined as a liquid mixture of heavy hydrocarbons. Sulfur in heavy hydrocarbon fuels may be present as inorganic or organic compounds that are dissolved in the fuel. In addition to sulfur, heavy hydrocarbons may have other heteroatoms in their molecules, such as oxygen, nitrogen, chlorine, other non-metals and metals. When reference is made to the term “substantial amount of sulfur,” it is intended to mean sulfur that is present in an amount of at least about 50 ppm. This sulfur can be in the form of inorganic sulfur compounds such as hydrogen sulfide, carbonyl sulfide, carbon disulfide etc., or organic sulfur compounds such as mercaptans and thiophenic compounds including benzothiophene, dibenzothiophene and their derivatives. Such sulfur compounds are found in commercial heavy hydrocarbons such as diesel and jet fuels. Some examples of heavy hydrocarbon fuels having a substantial amount of sulfur include logistic fuels such as JP-8 fuel, JP-5 fuel, JP-4 fuel, and No.2 fuel oil. Notwithstanding the foregoing, while “heavy hydrocarbon fuels” oftentimes contain a “substantial amount of sulfur,” the present invention contemplates that “heavy hydrocarbon fuels” may not have a “substantial amount of sulfur.” Likewise, a hydrocarbon having a “substantial amount of sulfur” may not be a “heavy hydrocarbon fuel.” The oxidizer gas source 12 provides an oxygen containing gas, i.e., a source of oxygen which serves as the oxidant in the oxidative reaction that will occur in the CPOX reactor 19, as further described below. Air is a desirable oxidizer gas source 14 because of cost and availability. Nevertheless, enriched air, pure oxygen or any other oxidizer source containing oxygen (atomic or molecular) can be utilized. Irrespective of what type of oxygen used, the oxidizer gas flows through a valve or other suitable metering means into the pre-reaction zone 24 of the CPOX reactor 19. The heavy hydrocarbon fuel flows from the fuel source 12 through a valve or other suitable metering means into the pre-reaction zone through a fine mist spray nozzle or other atomizing means. The fuel is desirably preheated to a temperature from about 150 to about 240° C. The fuel and air mix in the pre-reaction zone 24 to form a flowing feed gas mixture in the pre-reaction zone.

The regulated flow rates of both hydrocarbon fuel and oxidizer gas are provided to generally regulate the carbon to oxygen ratio. More specifically, the regulated flow rates enable regulation of a molar ratio of carbon atoms to oxygen atoms, with the number of carbon atoms being determined from the carbon content of the hydrocarbon fuel. The number of oxygen atoms is based upon the concentration of oxygen in the oxidizer gas.

As is known in the art, the carbon to oxygen (C/O) ratio can affect various aspects of a CPOX process, including hydrogen and carbon monoxide yields and carbon formation. In the present invention, it is useful to have a C/O ratio of not less than about 0.5. Preferably, the C/O ratio is from about 0.5 to 1.0, and more preferably about 0.6 to 0.8. Below a C/O ratio of about 0.5, deep oxidation tends to occur, leading to complete as opposed to partial combustion of the hydrocarbon to carbon dioxide and water. Above a C/O ratio of about 1.0, incomplete combustion, coke formation, and side reactions may tend to occur.

As appreciated by those skilled in the art, the total feed flow rate can affect a CPOX process, for example, in terms of catalytic contact time, i.e., duration of contact between the feed gas mixture and the catalyst within the reactor 19. The catalyst contact time is the ratio of the volumetric gas flow rate to the catalyst volume. The volumetric gas flow rate is the sum of the oxidizer gas and the vaporized hydrocarbon flow rates at standard conditions, assuming that the hydrocarbons are in the gas phase. For the open channel structure used as the catalyst support, the catalyst volume is taken as the cylindrical space in the reactor occupied by the open channel structure. Also affected by the feed flow rate is heat transfer and mass transfer limitations of the reactor 19. In general, the feed flow rate can vary with the size of the reactor 19 and the delivery rate of the feed gas mixture. Yet, the preferred feed flow rate in the present invention is largely dictated by a preferred catalytic contact time, as discussed below.

The feed gas mixture flows from the pre-reaction zone 24 into the catalytic reaction zone 22 passing through the pre-reaction radiation shield 42. The pre-reaction radiation shield 42 reduces the occurrence of premature reaction or backflash of the feed gas mixture in the pre-reaction zone 24. Initially, however, the catalytic reaction zone 22 is preheated to a temperature from about 900° C. to about 1250° C. to initiate the catalytic reaction of the feed gas mixture in the catalytic reaction zone 22. As the feed gas mixture flows from the pre-reaction radiation shield 42 into the catalytic structure 34, the feed gas mixture contacts the catalyst in the catalytic structure and is converted from hydrocarbon fuel to a mixture of hydrogen and carbon monoxide.

Although the catalyst can vary, it is desirably rhodium supported on a porous alumina monolith. Contact time between the feed gas mixture and the catalysts is regulated. In large part, the contact time is controlled by the feed flow rate and configuration of the catalyst. A higher feed flow rate will decrease the contact time.

For the present embodiment of the invention, it is beneficial to maintain a liquid hourly space volume (LHSV) of greater than about 0.5 h⁻¹, and preferably in the range of about 0.5 h⁻¹ to 75 h⁻¹. LHSV is defined as the liquid hydrocarbon flow rate per unit volume of catalyst, with the catalyst volume defined as the volume occupied by the monolith. A more tortuous flow path created by the catalytic structure 34 increases the contact time. The duration of the contact time is controlled in order to maximize partial oxidation and minimize further oxidation of hydrogen and carbon monoxide. Contact time is defined based on volumetric flow rates computed at standard temperature and pressure (STP) as follows:

$$Contact Time = \frac{Volume of the catalyst monolith ( cc ) \times 1000}{Flow rate of oxidizer gas + hydrocarbon vapor at STP ( cc / s )}$$

where the contact time is computed in milliseconds. The STP volumetric flow rate of hydrocarbon vapor is calculated by equating the hydrocarbon moles in the gas (vapor) phase to that in the liquid phase. Accordingly, for this embodiment of the invention, a useful contact time is not more than about 500 milliseconds. A preferred range of contact time is from about 10 to 500 milliseconds. More preferably, the contact time is about 50 to 200 milliseconds and, in particular, about 100 milliseconds. With a contact time of less than about 10 milliseconds, there is a tendency towards incomplete conversion. By limiting the contact time to about 500 milliseconds, the present embodiment of the invention can provide a catalytic reaction zone that does not become too large and unwieldy, and will be able to provide a compact, lightweight, catalytic partial oxidation fuel processor.

The reacting feed gas mixture flows from the catalytic structure 34 in the catalytic reaction zone 22 through the post reaction radiation shield 44 into the post reaction zone 26. Insulation about the post reaction zone 24 maintains the temperature of the exit gas stream at a temperature greater than about 600° C., or preferable greater than about 700° C., until the conversion of the feed gas mixture to hydrogen and carbon monoxide is substantially entirely complete.

As a result of the reaction parameters described above, the partial oxidation in the reaction zone produces an exit or product gas 60 that exits the reactor 19. The exit gas 60 comprises hydrogen gas, carbon monoxide, carbon dioxide, water vapor, hydrogen sulfide, methane, traces of unconverted hydrocarbons, traces of other sulfur compounds, and nitrogen, if the oxidizer gas is air or oxygen-enriched air.

In the embodiment of the invention, the exit gas 60 from each of the CPOX tube reactors may be manifolded to provide a single effluent exit gas stream to be manifolded into a fuel cell system.

Optionally, and following the step of recovering the exit gas 60, the exit gas 60 can be directed to a fuel cell system 18 indivudually into individual stacks of a multi-stack fuel cell system. This embodiment of the invention offers the additional advantage of finer control of the fuel cell due to individual control of the CPOX exit gas streams 60.

Any fuel cell system that has provisions to utilize the fuel content of the above detailed product gas stream can be employed. In this preferred embodiment, a solid oxide fuel cell system is contemplated as the fuel cell system 18. The fuel cell system 18 can be constructed according to well known methods in the art and can either have a sulfur tolerant design or, alternatively, have a provision for desulfurizing the product gas stream. Some examples of solid oxide fuel cells can be found in U.S. Pat. Nos. 4,913,982 and 4,379,109. With the solid oxide fuel cell systems 18 typically using carbon monoxide and hydrogen gas as its fuel, it can be appreciated that the product gas 60 serves to fuel the solid oxide fuel cell system.

While the CPOX reactor tubes 20 are producing syngas, the exothermic catalytic reaction produces a substantial amount of heat within the heat exchanger shell 27. Heat exchange fluid flows into the heat exchanger shell 27 through the heat exchange fluid inlet 56, through the shell body 50 of the heat exchanger shell, over the CPOX reactor tubes 19, and out of the heat exchanger shell through the heat exchange fluid outlet 58. The heat emitted by the catalytic reactions in the heat exchanger shell 27 heat the heat exchange fluid, which may desirably be air. In another embodiment of the invention, the heat exchange fluid could be employed to vaporize the liquid hydrocarbon fuel inlet stream 30. The heat exchange fluid cools the CPOX reactor tubes 20 and controls the reaction temperature therein and reduces the hazard of heat produced by the catalytic reaction for a safer, more efficient, and more reliable operation of the CPOX processor 16.

The heat recovered by the heat exchange fluid can be applied elsewhere such as in preheating the hydrocarbon fuel for the CPOX processor 16 or in any other applications where heat is useful.

It should be understood, of course, that the foregoing relates to preferred embodiments of the invention and that modifications may be made without departing from the spirit and scope of the invention as set forth in the following claims.

1. A catalytic partial oxidation processor comprising:
a shell having an inlet for receiving a flow of heat exchange fluid and an outlet for discharging the flow of heat exchange fluid; and
at least one catalytic partial oxidation reactor disposed in the shell such that heat from partial oxidation in the at least one catalytic partial oxidation reactor transfers from the at least one catalytic partial oxidation reactor to the heat exchange fluid in the shell.

2. A catalytic partial oxidation processor as in claim 1 further comprising a plurality of catalytic partial oxidation reactors including the at least one catalytic partial oxidation reactor, the plurality of catalytic partial reactors disposed in the shell such that heat from partial oxidation in the plurality of catalytic partial oxidation reactors transfers from the plurality of catalytic partial oxidation reactors to the heat exchange fluid in the shell.

3. A catalytic partial oxidation processor comprising:
a shell having a heat exchange fluid inlet for receiving a flow of heat exchange fluid and a heat exchange fluid outlet for discharging the flow of heat exchange fluid; at least one reactor tube disposed in the shell and having a hydrocarbon fuel inlet for receiving a feed gas mixture comprising a hydrocarbon fuel and an oxygen containing gas and an exit gas stream outlet for discharging an exit gas stream comprising the mixture of hydrogen and carbon monoxide, the at least one reactor tube forming a reaction flow passage extending from the hydrocarbon fuel inlet to the exit gas stream outlet and a catalytic reaction zone between the hydrocarbon fuel inlet and the exit gas stream outlet; and
a catalytic structure disposed in the catalytic reaction zone of the at least one reactor tube and comprising an oxidation catalyst for catalyzing a partial oxidation reaction of the feed gas mixture to form the exit gas stream; so that when the feed gas mixture is fed through the hydrocarbon fuel inlet, said feed gas mixture passes along the reaction flow passage and through said catalytic structure, said feed gas mixture converts in the catalytic structure to the exit gas stream, the exit gas stream discharges through the outlet, and heat from the partial oxidation reaction transfers from the at least one reaction tube to the heat exchange fluid in the shell.

4. A catalytic partial oxidation processor as in claim 3, wherein the oxidation catalyst is a noble metal.

5. A catalytic partial oxidation processor as in claim 3, wherein the shell extends from one end to another and the at least one reaction tube extends from the one end to the other end.

6. A system for producing electric power comprising:
a shell having an inlet for receiving a flow of heat exchange fluid and an outlet for discharging the flow of heat exchange fluid;
at least one catalytic partial oxidation reactor for the catalytic partial oxidation of heavy hydrocarbon fuel to produce an exit gas stream containing hydrogen and carbon monoxide as main reaction products, the at least one catalytic partial oxidation reactor disposed in the shell such that heat from partial oxidation in the at least one catalytic partial oxidation reactor transfers from the at least one catalytic partial oxidation reactor to the heat exchange fluid in the shell; and
a fuel cell disposed for receiving the exit gas stream and consuming the hydrogen to produce electric power.

7. A method for the catalytic partial oxidation of hydrocarbon fuel comprising:
feeding a feed gas mixture comprising an oxygen containing gas and a hydrocarbon fuel through at least one catalytic partial oxidation reactor disposed in a shell;
reacting the feed gas mixture in the at least one catalytic partial oxidation reactor in the presence of an oxidation catalyst to convert the feed gas mixture to an exit gas mixture of hydrogen and carbon monoxide; and
passing a heat exchange fluid through the shell and past the at least one catalytic partial oxidation reactor with the heat exchange fluid in the shell flowing in the same direction of reactant flow in the catalytic partial oxidation reactor tube such that heat from partial oxidation in the at least one catalytic partial oxidation reactor transfers from the at least one catalytic partial oxidation reactor to the heat exchange fluid in the shell.

8. A method as in claim 7, wherein the hydrocarbon fuel is a heavy hydrocarbon fuel.

9. A method as in claim 8, wherein said heavy hydrocarbon fuel comprises a plurality of hydrocarbon molecules, with substantially all of said molecules each containing at least 6 carbon atoms.

10. A method as in claim 8, wherein said heavy hydrocarbon fuel is selected from the group consisting of gasoline, kerosene, jet fuel, and diesel fuel.

11. A method as in claim 7, wherein said oxidation catalyst is a noble metal.

12. A method as in claim 7, wherein the partial oxidation reaction is maintained at a temperature greater than about 900° C.

13. A method for producing electric power comprising the steps of:
feeding a feed gas mixture comprising an oxygen containing gas and a hydrocarbon fuel through at least one catalytic partial oxidation reactor disposed in a shell;
reacting the feed gas mixture in the at least one catalytic partial oxidation reactor in the presence of an oxidation catalyst to convert the feed gas mixture to an exit gas mixture of hydrogen and carbon monoxide;
passing a heat exchange fluid through the shell and past the at least one catalytic partial oxidation reactor with the heat exchange fluid in the shell flowing in the same direction of reactant flow in the catalytic partial oxidation reactor tube such that heat from partial oxidation in the at least one catalytic partial oxidation reactor transfers from the at least one catalytic partial oxidation reactor to the heat exchange fluid in the shell; and
directing said exit gas mixture to said solid oxide fuel cell system.

14. A method as in claim 13, wherein the hydrocarbon fuel is a heavy hydrocarbon fuel.

15. A method as in claim 14, wherein said heavy hydrocarbon fuel comprises a plurality of hydrocarbon molecules, with substantially all of said molecules each containing at least 6 carbon atoms.

16. A method as in claim 14, wherein said heavy hydrocarbon fuel is selected from the group consisting of gasoline, kerosene, jet fuel, and diesel fuel.

17. A method as in claim 13, wherein said oxidation catalyst is a noble metal.

18. A method as in claim 13, wherein the partial oxidation reaction is maintained at a temperature greater than about 900° C.
